(19) United States
(12) Patent Application Publication
(10) Pub. No.: US 2007/0043124 A1
(43) Pub. Date: Feb. 22, 2007

(54) Dispersion for chemical-mechanical polishing

(75) Inventors: Ralph Brandes, Princeton, NJ (US); Frederick Klaessig, Doylestown, PA (US); Thomas Knothe, Randolph, NJ (US); Frank Menzel, Hanau (DE); Wolfgang Lortz, Wachtersbach (DE); Takeyoshi Shibasaki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/555,444

(22) PCT Filed: Apr. 24, 2004
(86) PCT No.: PCT/EP04/04356

§ 371 Date: Nov. 3, 2005

(30) Foreign Application Priority Data
May 9, 2003 (DE) 103 20 854.2

(51) Int. Cl. B01F 3/12; B24D 3/02; C01B 33/141; C09K 3/14

(52) U.S. Cl. 516/79; 51/308; 51/309; 516/88

(57) ABSTRACT

An aqueous dispersion having a pH value of between 3 and 7 containing 1 to 35 wt. % of a pyrogenically produced silicon-aluminium mixed oxide powder with a specific surface area of 5 to 400 m²/g, wherein the proportion of aluminium oxide in the powder is between 90 and 99.9 wt. % or between 0.01 and 10 wt. %, the surface of the powder comprises zones of aluminium oxide and silicon dioxide and the powder exhibits no signals for crystalline silicon dioxide in an X-ray diffractogram. Said dispersion may be used for the chemical-mechanical polishing of conductive, metallic films.

The present invention provides an aqueous dispersion for the chemical-mechanical polishing of metallic films, said dispersion containing a silicon-aluminium mixed oxide powder.

Integrated circuits consist of millions of active devices formed in or on a silicon substrate. The active devices, which are initially isolated from one another, are connected together in order to form functional circuits and components. The devices are connected together by using known multi-level interconnection means. Interconnection structures normally comprise a first metallisation layer, an interconnection layer, a second metallisation level and sometimes a third and subsequent metallisation level. Dielectric interlayers, such as for example doped silicon dioxide (SiO₂) or tantalum nitride with a low dielectric constant are used to provide electrical insulation for the various metallisation levels in a silicon substrate. The electrical connections between different interconnection levels are produced by using metallised vias.

Metal contacts and vias are used in a similar manner to form electrical connections between interconnection levels. The metal vias and contacts may be filled with various metals and alloys, for example copper (Cu) or tungsten (W). A barrier layer, for example consisting of titanium nitride (TiN), titanium (Ti), tantalum (Ta), tantalum nitride (TaN) or combinations thereof, is generally used in the metal vias and contacts to effect adhesion of the metal layer to the SiO₂ substrate. At the contact level, the barrier layer acts as a diffusion barrier in order to prevent the metal filling and SiO₂ from reacting.

A semiconductor manufacturing process generally involves a chemical-mechanical polishing (CMP) step, during which excess metal is removed. It is desirable for the dispersions used in chemical-mechanical polishing to exhibit elevated metal film:barrier layer selectivity.

Dispersions containing aluminium oxide are normally used for this purpose. The disadvantage of these dispersions is their often low stability in the pH range between 4 and 7. Flocculation may occur, which makes it impossible to achieve a reproducible polishing result. Furthermore, the selectivity between barrier layer and metal film may not be adequate and overpolishing may occur.

Attempts have been made to counter such phenomena with dispersions which contain mixtures of abrasive particles.

U.S. Pat. No. 6,444,139 describes the use of dispersions for polishing metallic layers, said dispersions containing particles of silicon-aluminium mixed oxide crystals (“mixed crystal abrasives”) with variable proportions of the oxides of in each case 10 to 90 wt. %. The origin of these particles is not disclosed.

U.S. Pat. No. 6,447,694 describes the use of dispersions for polishing metal layers, said dispersions containing a silicon-aluminium oxide composite. The composite is preferably obtained from a pyrogenic process. The content of aluminium oxide is preferably 67±15 wt. %. It has, however, been found that precisely this composition of abrasive particles results in inadequately stable dispersions in the acidic range. On use in polishing processes, settling and/or flocculation result in craters and non-uniform material removal.

The object of the invention is to provide a dispersion which exhibits good stability and which, in chemical-mechanical polishing processes, exhibits an elevated metal removal rate combined with a low barrier layer removal rate.

Said object is achieved by an aqueous dispersion having a pH value of between 3 and 7 containing 1-35 wt. % of a pyrogenically produced silicon-aluminium mixed oxide powder with a specific surface area of between 5 and 400 m²/g, said dispersion being characterised in that
the proportion of aluminium oxide in the powder is between 90 and 99.9 wt. % or between 0.01 and 10 wt. %,
the surface of the powder comprises zones of aluminium oxide and silicon dioxide,
the powder exhibits no signals for crystalline silicon dioxide in an X-ray diffractogram.

The dispersion according to the invention contains a pyrogenically produced silicon-aluminium mixed oxide powder. A suitable powder is, for example, one which is produced by a “co-fumed” process in which the precursors of silicon dioxide and aluminium oxide are mixed and then combusted in a flame.

The mixed oxide powder described in DE-A-19847161 is also suitable.

Silicon dioxide powders partially covered with aluminium oxide or aluminium oxide powders partially covered with silicon dioxide are also suitable for the dispersion according to the invention. The production of these powders is described in US-A-2003-22081.

The powders should here be selected such that the aluminium oxide content thereof is between 90 and 99.9 wt. % or between 0.01 and 10 wt. %. In powders suitable for the dispersion according to the invention, the surface comprises zones of aluminium oxide and silicon dioxide and no signals for crystalline silicon dioxide are visible in the X-ray diffractogram.

It may be advantageous for certain applications if the dispersion according to the invention contains 0.3-20 wt. % of an oxidising agent. Hydrogen peroxide, a hydrogen peroxide adduct, for example the urea adduct, an organic per-acid, an inorganic per-acid, an imino per-acid, a persulfate, perborate, percarbonate, oxidising metal salts and/or mixtures of the above may be used for this purpose. Hydrogen peroxide may particularly preferably be used. Due to the lower stability of some oxidising agents relative to other constituents of the dispersion according to the invention, it may be advisable not to add the oxidising agent until immediately before use of the dispersion.

The dispersion according to the invention may furthermore contain additives from the group of pH-regulating substances, oxidation activators, corrosion inhibitors and/or surface-active substances.

The pH value may be established by acids or bases. Acids which may be used are inorganic acids, organic acids or mixtures of the above.

Inorganic acids which may in particular be used are phosphoric acid, phosphorous acid, nitric acid, sulfuric acid, mixtures thereof and the acidically-reacting salts thereof.

Organic acids which are preferably used are carboxylic acids of the general formula CₙH₂ₙ₊₁CO₂H, where n=0-6 or n=8, 10, 12, 14, 16, or dicarboxylic acids of the general formula HO₂C(CH₂)ₙCO₂H, where n=0-4, or hydroxycarboxylic acids of the general formula R₁R₂C(OH)CO₂H, where R₁=H, R₂=CH₃, CH₂CO₂H, CH(OH)CO₂H, or phthalic acid or salicylic acid or the acidically-reacting salts of the above-stated acids or mixtures of the above-stated acids and the salts thereof.

The pH value may be increased by addition of ammonia, alkali metal hydroxides or amines. Ammonia and potassium hydroxide are particularly preferred.

Suitable oxidation activators may be the metal salts of Ag, Co, Cr, Cu, Fe, Mo, Mn, Ni, Os, Pd, Ru, Sn, Ti, V and mixtures thereof. Carboxylic acids, nitriles, ureas, amides and esters are also suitable. Iron(II) nitrate may be particularly preferred. Depending upon the oxidising agent and the polishing task, the concentration of the oxidation catalyst may be varied within a range between 0.001 and 2 wt. %. The range may particularly preferably be between 0.01 and 0.05 wt. %.

Suitable corrosion inhibitors, which may be present in the dispersion according to the invention in a proportion of 0.001 to 2 wt. %, comprise the group of nitrogenous heterocycles, such as benzotriazole, substituted benzimidazoles, substituted pyrazines, substituted pyrazoles, glycine and mixtures thereof.

The dispersion may be further stabilised, for example against settling of the silicon-aluminium mixed oxide powder, flocculation and decomposition of the oxidising agent by adding 0.001 to 10 wt. % of at least one surface-active substance, which is of the nonionic, cationic, anionic or amphoteric type.

In addition to the silicon-aluminium mixed oxide powder, the dispersion according to the invention may contain at least a further metal oxide powder from the group comprising silicon dioxide, aluminium oxide, cerium oxide, zirconium oxide and titanium dioxide. The nature and proportion of these powders in the dispersion according to the invention are determined by the intended polishing task. The proportion of this powder may preferably be no more than 20 wt. %, relative to the silicon-aluminium mixed oxide powder.

The present invention also provides a process for the production of the dispersion with dispersion and/or grinding apparatuses which provide an energy input of at least 200 kJ/m³. Such apparatuses include systems operating by the rotor-stator principle, for example Ultra-Turrax machines, or stirred ball mills. Higher energy inputs are possible with a planetary kneader/mixer. The efficacy of this system is, however, associated with a sufficiently high viscosity of the mixture being processed in order to input the required elevated shear energies to break down the particles.

Using high pressure homogenisers, it is possible to obtain dispersions in which the silicon-aluminium mixed oxide powder is present in the dispersion in the form of aggregates smaller than 150 nm and particularly preferably smaller than 100 nm.

In these apparatuses, two pressurised, predispersed streams of suspension are depressurised through a nozzle. The two dispersion jets collide exactly with one another and the particles grind one another. In another embodiment, the predispersion is likewise raised to an elevated pressure, but the particles collide against armoured areas of wall. The operation can be repeated as often as desired in order to obtain smaller particle sizes.

The dispersion and grinding apparatuses may also be used in combination. Oxidising agents and additives may be added at various points in time during dispersion. It may also be advantageous not to incorporate the oxidising agents and oxidation activators, for example, until the end of dispersion, optionally with a low energy input.

The present invention also provides the use of the dispersion according to the invention for the chemical-mechanical polishing of conductive, metallic films. These may be films consisting of copper, aluminium, tungsten, titanium, molybdenum, niobium and tantalum.

The present invention also provides the use of the dispersion according to the invention for the chemical-mechanical polishing of conductive, metallic films which are applied on an insulating barrier layer. The metal films comprise the metals copper, aluminium, tungsten, titanium, molybdenum, niobium, tantalum. The barrier layers may, for example, consist of silicon dioxide or tantalum nitride.

### EXAMPLES

Dispersions

Dispersions D_{n/m} with a solids content of 2 and 5 wt. % of powder Pₙ (Table 1) are produced by dispersion by means of an Ultraturrax, manufactured by IKA. The index n here refers to the powder used, m to the solids content of the powder in the dispersion. Dispersion D_{3/5}, for example, comprises 5 wt. % of powder P₃. The dispersions are then adjusted with KOH to pH 4-5 or to pH 6 and 1.3 wt. % of glycine and 7.5 wt. % of hydrogen peroxide are added.

Powders P₄ and P₅ and the associated dispersions serve as Comparative Examples.

Polishing Tests

Polishing Tools and Parameters

Polishing machine: MECAPOL E460 (STEAG) with 46 cm platen and 6″ wafer carrier.
Polishing pad: IC1400 (RODEL Corp.)
   Pad conditioning with diamond segment after each polished wafer
Slurry rate: 120 ml/min
Polishing parameters: Operating pressure: 10-125 kPa (1.45-18.13 psi)
   Standard: 45 and 60 kPa
   Reverse side pressure: 10 kPa ωₚ=ω_{c}=40 rpm; sweep=4 cm
Polishing time: 2 min

Post-cleaning: After polishing, the substrate was rinsed for 30 s with deionised water and was then cleaned on both sides in a brush cleaning unit with spray jet and megasonic assistance and then spun dry.

TABLE 1
Silicon-aluminium mixed oxide powders

| | | | | BET |
|---|---|---|---|---|
| | | | Al₂O₃ | surface |
| | | Produced | content | area |
| | Powder | According to | wt. % | m²/g |
| P₁ | SiO₂ doped with | DE-A-19847161 | 0.19 | 55 |
| | Al₂O₃ | (Example 1) | | |
| P₂ | SiO₂ partially | US-A-2003/22081 | 4.2 | 48 |
| | covered with | (Example 18) | | |
| | Al₂O₃ | | | |
| P₃ | “cofumed” | corresponding to | 91 | 90 |
| | SiO₂/Al₂O₃ | EP-A-585 544 | | |
| P₄ | “co-fumed” | corresponding to | 67 | 100 |
| | SiO₂/Al₂O₃ | EP-A-585 544 | | |
| P₅ | Al₂O₃⁽*⁾ | — | — | 90 |

⁽*⁾Aluminium oxide C, Degussa AG

TABLE 2
Stability of dispersions

Stability of dispersion after

| | 14 days without | 24 hours with oxidising |
|---|---|---|
| Example | oxidising agent | agent |
| D_{1/2} | no separation | no evolution of O₂ |
| | | no separation |
| D_{1/5} | no separation | no evolution of O₂ |
| | | no separation |
| D_{2/2} | no separation | no evolution of O₂ |
| | | no separation |
| D_{2/5} | no separation | no evolution of O₂ |
| | | no separation |
| D_{3/2} | no separation | slight evolution of O₂ |
| | | slight separation |
| D_{3/5} | no separation | slight evolution of O₂ |
| | | slight separation |
| D_{4/2} | separation | slight evolution of O₂ |
| | | separation |
| D_{4/5} | separation | slight evolution of O₂ |
| | | separation |
| D_{5/2} | no separation | evolution of O₂ |
| | | slight separation |
| D_{5/5} | no separation | evolution of O₂ |
| | | slight separation |

Wafers Used
Copper: 6″ wafer with 140 nm oxide, 50 nm TaN and approx. 500 or 1000 nm PVD copper over entire surface
Tantalum nitride: 6″ wafer with 140 nm oxide and approx. 100 nm PVD tantalum nitride over entire surface
   Evaluation

The polishing rate is determined from the difference in layer thickness. The layer thickness of Cu and TaN is determined by measuring the electrical resistance of the layer (Waferprober AVT 110).

The polishing results are shown in Table 3. Dispersions D₁ to D₃ according to the invention exhibit elevated removal rates and good Cu:TaN selectivity combined with good stability. Dispersions D₄, which contain a “co-fumed” silicon-aluminium mixed oxide powder with an aluminium oxide content of 67 wt. %, also exhibit elevated removal rates combined with good selectivity, but the stability of dispersions D₄ is distinctly lower than that of dispersions D₁ to D₃ according to the invention. With regard to selectivity, dispersions D₁ to D₃ according to the invention exhibit distinct advantages over the aluminium oxide dispersions D₅.

TABLE 3
Removal rates and selectivities

| | Operating | pH 4-5 | | | | pH 6 | | | |
|---|---|---|---|---|---|---|---|---|---|
| | pressure | RR Cu | RR TaN | Cu:TaN | ΔRR/Δp_{A} | RR Cu | RR TaN | Cu:TaN | ΔRR/Δp_{A} |
| Example | p_{A} kPa | nm/min | nm/min | selectivity | 1/kpa | nm/min | nm/min | selectivity | 1/kpa |
| D_{1/2} | 45 | 144 | | | | 135 | | | |
| | 60 | 220 | 4 | 55 | 5.1 | 167 | 20 | 8.4 | 2.1 |
| D_{1/5} | 45 | 179 | | | | 168 | | | |
| | 60 | 281 | 5 | 56 | 6.8 | 247 | 15 | 16.5 | 5.3 |
| D_{2/2} | 45 | 286 | | | | 182 | | | |
| | 60 | 392 | 3 | 131 | 7.1 | 240 | 10 | 24 | 2.5 |
| D_{2/5} | 45 | 324 | | | | 202 | | | |
| | 60 | 519 | 4 | 130 | 13 | 302 | 15 | 20 | 6.7 |
| D_{3/2} | 45 | 242 | | | | 170 | | | |
| | 60 | 300 | 3 | 100 | 3.9 | 251 | | | 5.4 |
| D_{3/5} | 45 | 272 | | | | 183 | | | |
| | 60 | 331 | 3 | 110 | 3.9 | 240 | 10 | 10 | 3.8 |
| D_{4/2} | 45 | 200 | | | | 167 | | | |
| | 60 | 310 | 3 | 103 | 7.3 | 235 | | | 4.5 |
| D_{4/5} | 45 | 260 | | | | 175 | | | |
| | 60 | 404 | 3 | 101 | 9.6 | 259 | 17 | 15 | 5.6 |
| D_{5/2} | 45 | 137 | | | | 121 | | | |
| | 60 | 155 | 10 | 16 | 1.2 | 164 | 30 | 5.5 | 2.9 |
| D_{5/5} | 45 | 164 | | | | 125 | | | |
| | 60 | 205 | 25 | 8 | 2.7 | 182 | 39 | 4.7 | 3.8 |

RR = average polishing rate

1. An aqueous dispersion having a pH value of between 3 and 7 comprising 1 to 35 wt. % of a pyrogenically produced silicon-aluminium mixed oxide powder with a specific surface area of 5 to 400 m²/g, wherein
the proportion of aluminium oxide in the powder is between 90 and 99.9 wt. % or between 0.01 and 10 wt. %;
the surface of the powder comprises zones of aluminium oxide and silicon dioxide; and
the powder exhibits no signals for crystalline silicon dioxide in an X-ray diffractogram.

2. The aqueous dispersion according to claim 1, wherein the dispersion comprises 0.3-20 wt. % of an oxidizing agent.

3. The aqueous dispersion according to claim 1, wherein the dispersion comprises additives.

4. The aqueous dispersion according to claim 1, wherein, in addition to the silicon-aluminium mixed oxide powder, the dispersion comprises at least a further metal oxide powder selected from the group consisting of silicon dioxide, aluminium oxide, cerium oxide, zirconium oxide and titanium dioxide.

5. A method of chemical-mechanical polishing of conductive, metallic films comprising polishing conductive, metallic films with the aqueous dispersion according to claim 1.

6. A method of chemical-mechanical polishing of conductive, metallic films comprising polishing conductive, metallic films with the aqueous dispersion according to claim 1, wherein the conductive, metallic films are applied on an insulating barrier layer.
